(19) United States
(12) Patent Application Publication
(10) Pub. No.: US 2009/0096182 A1
(43) Pub. Date: Apr. 16, 2009

(54) MACHINE BASE DOCKING SYSTEM

(75) Inventors: Timothy Robert Hedlund, Eden Prairie, MN (US); Scott M. Albrecht, Minneapolis, MN (US)

Correspondence Address: PAULY, DEVRIES SMITH & DEFFNER, L.L.C., Plaza VII-Suite 3000, 45 South Seventh Street, MINNEAPOLIS, MN, 55402-1630, US

(73) Assignee: Durabotics Inc., Eden Prairie, MN (US)

(21) Appl. No.: 12/248,579

(22) Filed: Oct. 9, 2008

Related U.S. Application Data
(60) Provisional application No. 60/978,787, filed on Oct. 10, 2007.

(51) Int. Cl. F16M 11/04; F16M 11/20

(52) U.S. Cl. 280/79.11; 248/346.03

(57) ABSTRACT

A base having a first engaging member, second engaging member, and third engaging member configured to be docked to a docking plate, where the docking plate has a first mating member, a second mating member and a third mating member that are each configured to mate with the first engaging member, second engaging member, and third engaging member, respectively, of the base. The base has a locking mechanism with the third engaging member positioned thereon, and the locking mechanism is moveable between an engaged position and a disengaged position, where the third engaging member is coupled to the third mating member when the locking mechanism is in the engaged position.

This application is a non-provisional application claiming priority to U.S. Provisional Application No. 60/978,787, filed Oct. 10, 2007, and the entire contents of the U.S. Provisional Application are incorporated herein by reference.

### FIELD OF THE INVENTION

The current technology relates to machines. More particularly, the current technology relates to a machine base docking system.

### SUMMARY OF THE INVENTION

The current application discloses a machine base docking system where a docking plate is installed on a floor or other surface and has a first mating member, a second mating member and a third mating member. Each mating member couples to a first engaging member, second engaging member, and third engaging member, respectively, of a base that receives and secures a machine. A locking mechanism carries the third engaging member, and when the locking mechanism is engaged, the third engaging member is coupled to the third mating member. Reactionary forces also couple the first mating member to the first engaging member and the second mating member to the second engaging member. When the lock is disengaged, each mating member is decoupled from each respective engaging member. In various embodiments there can be multiple docking plates so that the base and machine can be moved and docked to various locations. Other embodiments are also disclosed.

### BRIEF DESCRIPTION OF THE DRAWINGS

The invention may be more completely understood and appreciated in consideration of the following detailed description of various embodiments of the invention in connection with the accompanying drawings.

FIG. 1 is a perspective view of a base and a machine consistent with one embodiment of the technology disclosed herein.

FIG. 2 is a perspective view of a base consistent with one embodiment of the technology disclosed herein.

FIG. 3 is a perspective view of a base consistent with one embodiment of the technology disclosed herein.

FIG. 4 is a perspective view of a base mounted on a docking plate consistent with one embodiment of the technology disclosed herein.

FIG. 5 is a perspective view of a docking plate consistent with one embodiment of the technology disclosed herein, and identifying section A.

FIG. 6 is a detailed view of section A of FIG. 5.

FIG. 7 is a top view of a docking plate, consistent with one embodiment of the technology disclosed herein.

FIG. 8 is a bottom view of a base mounted on the docking plate consistent with one embodiment of the technology disclosed herein.

FIG. 9 is a bottom perspective view of a base mounted on the docking plate consistent with one embodiment of the technology disclosed herein.

FIG. 10 is a bottom perspective view of a base having a locking mechanism in an engaged position consistent with one embodiment of the technology disclosed herein.

FIG. 11 is a perspective view of a locking mechanism consistent with one embodiment of the technology disclosed herein.

FIG. 12 is a bottom perspective view of a base having a locking mechanism in a disengaged position consistent with one embodiment of the technology disclosed herein.

FIG. 13 is a detailed view of section B of FIG. 12.

FIG. 14 is a bottom view of a base consistent with an alternative embodiment of the technology disclosed herein.

FIG. 15 is a detailed view of section C of FIG. 14.

FIG. 16 is a depiction of an example implementation of the technology disclosed herein.

### DETAILED DESCRIPTION

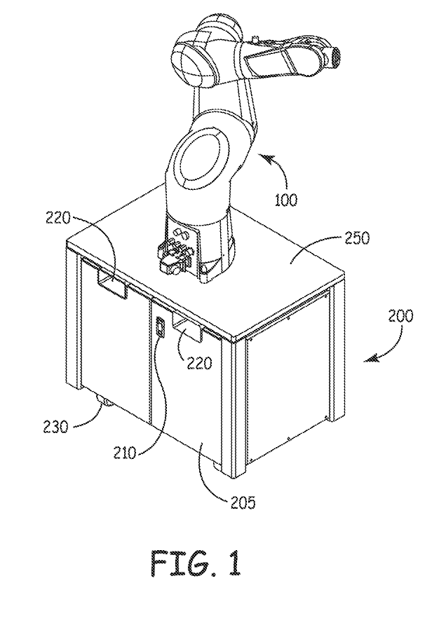

FIG. 1 is a perspective view of a base and a machine consistent with one embodiment of the technology disclosed herein. A machine 100 is coupled to the top surface 250 of a base 200. The base 200 has a top surface 250, wheels 230, sleeves 220, access panels 205, and a front panel lock 210.

In multiple embodiments the machine 100 is a robot. In such scenarios the robot has at least minimal automation for completion of simple to complex tasks. Those tasks can be associated with manufacturing, although other tasks are also contemplated. In embodiments where the machine 100 is in a manufacturing situation, the machine 100 can perform multiple tasks at various points in production. For example, the machine 100 can perform labeling, and, when moved to a different point in the production chain, the machine 100 can also perform assembling.

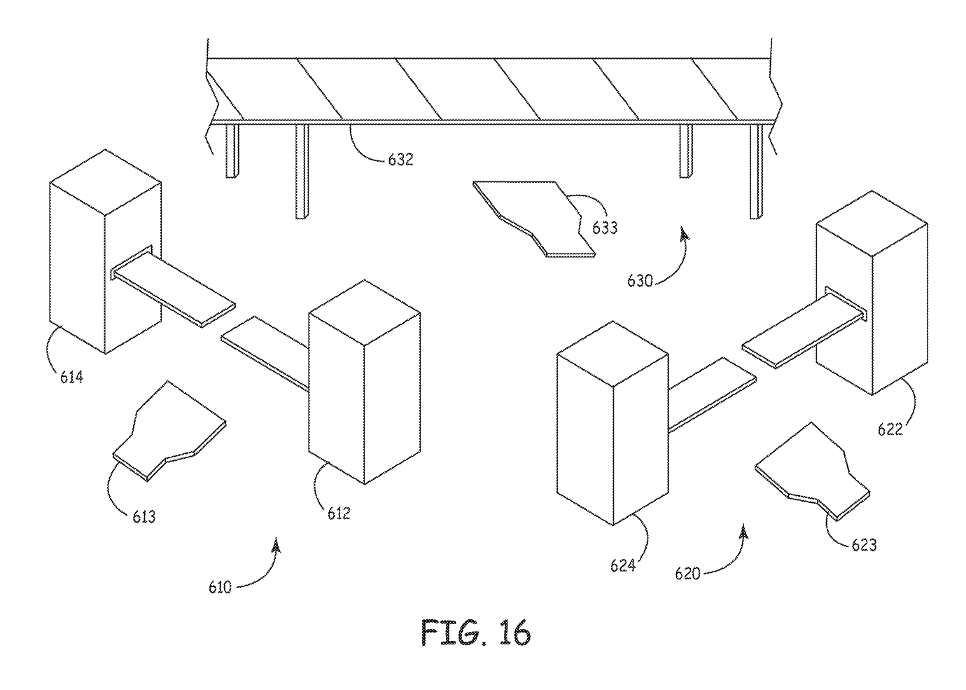

FIG. 16 depicts such an example implementation. A first docking plate 613, second docking plate 623, and third docking plate 633 are installed at a first work station 610, second work station 620, and third work station 630, respectively. The first work station 610 has a first work table 612 and a second work table 614. The second work station 620 has a third work table 622 and a fourth work table 624. The third work station 630 is proximate to a conveyor belt 632. The machine 100 and base 200 of FIG. 1 are docked to a docking plate such that the machine is in the substantially appropriate position to complete the required tasks at the workstation. The wheels of the base 200 facilitate rolling the base to the different docking stations to perform different tasks at different times. As a result, machines such as robotic systems can be moved between applications and more value can be derived from investments in equipment.

Generally, set of up the system includes determining a desired location of the machine 100 to perform the required tasks at the particular work station, and then docking plate is secured to the floor proximate to that location on a surface such as the floor. The base 200 holding the machine is mounted to the docking plate and the machine is programmed to complete the particular tasks. Such programming is stored so that the machine 100 and the base 200 can be moved from one docking plate to another without having to reprogram the machine. The docking plates determine the particular position and location of the base and machine, so that re-attaining the original, precise positioning of the machine is as simple as repeating the docking process. The docking process itself is explained in more detail throughout the rest of this application.

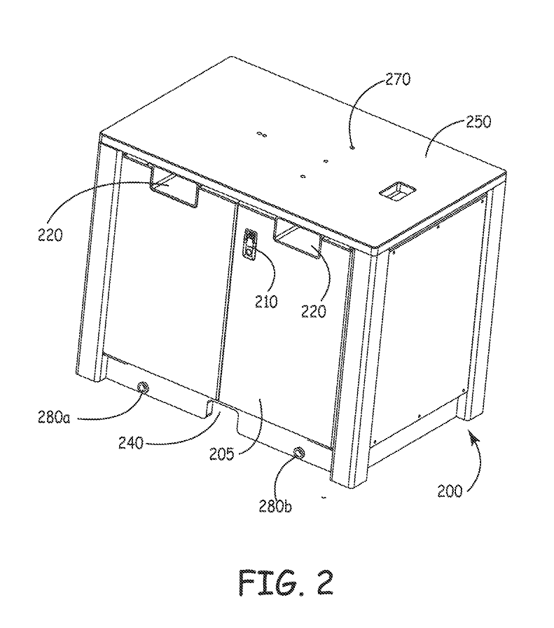

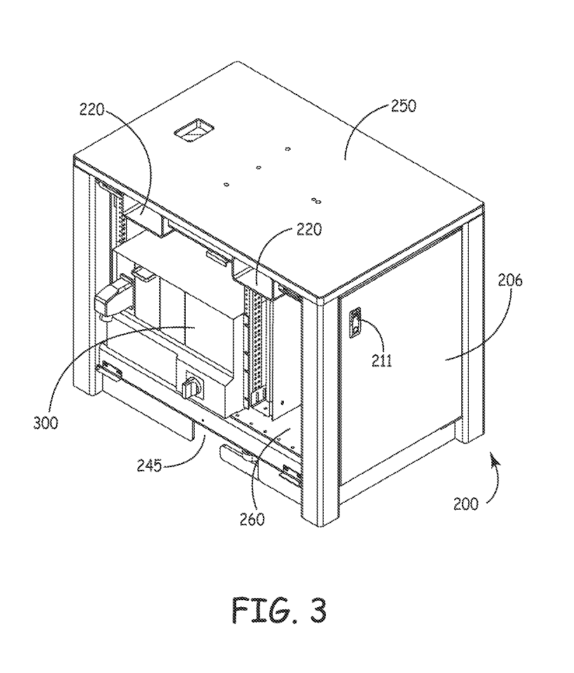

Back to FIG. 1, the base 200 is a structure that supports that machine 100 on the top surface 250 of the base 200. The base 200 can house machine 100 components in a cavity defined therein, which is described in more detail in the description of FIG. 3, below. Such machine components can be accessed through one or more access panels 205 that has a lock 210. The access panel 205 can be mounted to the base 200 in a variety of ways consistent with what is known in the art. The access panel 205 can be slidably mounted, for example, so it is slid to provide access to the machine components, or pivotally mounted in another example, so that it is swung out to provide access to the machine components. The embodiment of FIG. 2 has two panels 205 that are hinged along their outer edges. The base 200 and access panel 205 can be a variety of shapes and sizes to be consistent with the technology disclosed within this application. In the embodiment shown, the base 200 is in the shape of a cuboid.

The base 200 also has wheels 230 that are disposed at the bottom of the base 200. The wheels 230 are for engaging a surface such as a floor. The wheels 230 can aid in transferring the base 200 and machine 100 from one location to another across the surface such as a floor. For example, when the assembly is used in a manufacturing scenario, wheels may aid in moving the base 200 and machine 100 from one point in the production chain to another point in the production chain. The wheels 230 can be of any sort generally known in the art, and can be as numerous as required by the particular embodiment of the technology disclosed herein. In various embodiments, including the embodiment shown in FIG. 1, there are four wheels 230 disposed at the bottom of the base 200. In embodiments where the base 200 is in a cylindrical shape, it may be desirable to use five or more wheels to increase stability of the base 200. To facilitate positioning of the base 200, at least two of the wheels 230 can be pivotally mounted to the bottom of the base 200. The wheels 230 are constructed of materials that are sufficient for supporting the weight of the base 200 and the machine 100, and moving that weight across various distances. In various configurations, the wheels 230 have a diameter between about 5 inches and 8 inches.

The base 200 defines sleeves 220 that are configured to receive fork tongs of a conventional forklift, for example. In a variety of scenarios a forklift can be used for moving the base to alternate locations. The sleeves 220 can generally be defined by the base 100 at any location on the base 200 to allow receipt of the base 200 and machine 100 by a forklift, and transfer of the base 200 and machine by the forklift to an alternate location. For example, the sleeves 220 may be near the bottom of the base 200. In the embodiment shown, the sleeves 220 abut the top surface 250 of the base 200. This configuration causes the attachment point of the forklift to be closer to the center of gravity of the base 200 and machine 100 relative to other potential locations of the sleeves 220 on the base 200. In alternate embodiments the base 200 can have sleeves 220 and no wheels 230 or wheels 230 and no sleeves 220. Other components allowing movement of the base 200 and machine 100 can also be incorporated.

FIG. 2 is a back perspective view of a base consistent with one embodiment of the technology disclosed herein. In this view the base 200 does not have a machine (such as one depicted in FIG. 1) thereon, and it can be seen that the top surface 250 of the base 200 is configured to receive a machine 100. The top surface 250 of the base 200 is also configured to secure a machine 100 in various embodiments. The top surface 250 of the base defines a plurality of apertures 270 to accommodate, for example, cables associated with the machine that might lead from the outside of the base 200 to the inside of the base 200. Apertures 270 can also receive bolts or the like that attach to the machine. Apertures 270, grooves, and the like, can also be defined for accommodating and defining the particular placement of the machine. For example, the bottom of a machine may define one or more protrusions that are configured to be received by one or more particular apertures 270 on the base 200.

The back of the base 200 can also have access panels 205 such that components on the back side of the interior of the base 200 can be more easily accessed. These access panels may also have a lock 210.

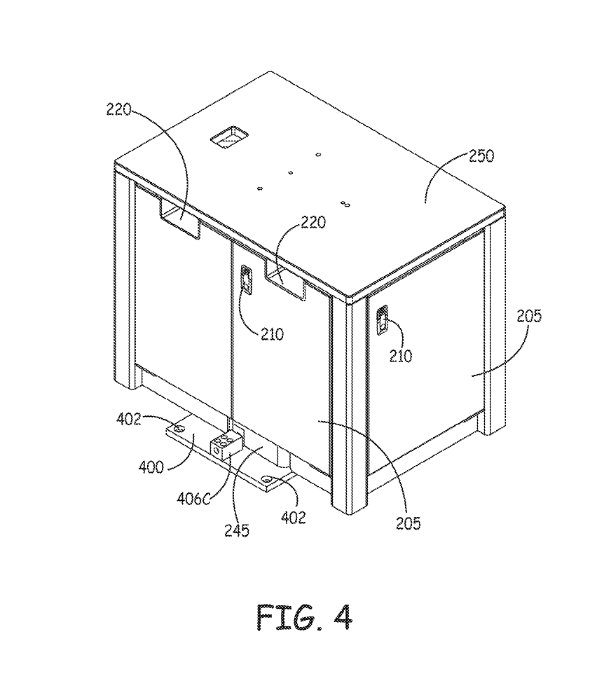

The base 200 defines a clearance opening 240 on the bottom of the base 200 that is designed for clearance of components of the system that are described in more detail in the description of FIG. 4, below. A first engaging member 280a and second engaging member 280b are on the outside surface of the bottom of the base 200 for docking the base to a docking plate. In this embodiment the first engaging member 280a and second engaging member 280b are female components that are configured to be coupled to corresponding male components on a docking plate. This is described in more detail starting at FIG. 4.

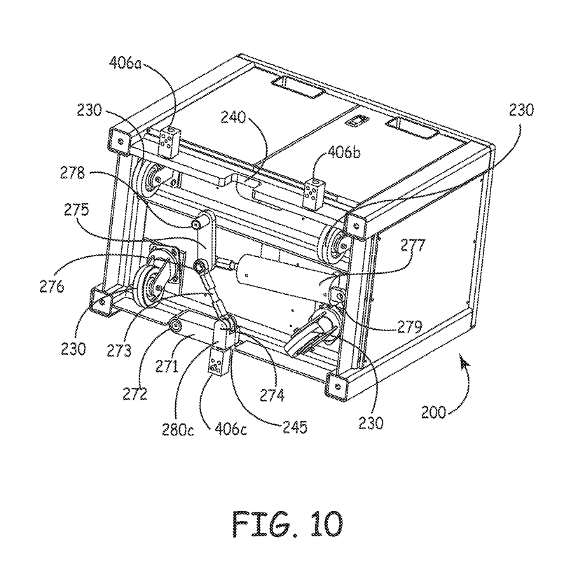

FIG. 3 is a perspective view of a base consistent with one embodiment of the technology disclosed herein. Machine components 300 are generally stored in the cavity 260 defined by the base 200. Machine components 300 can be controller and automation equipment including processors, data storage devices, hard drives, networking equipment, batteries, other general electronics, and the like. A hydraulic, pneumatic, or mechanical system for operating a locking mechanism, as described below in the description of FIGS. 10 through 13, are also considered machine components that are stored in the cavity 260 defined by the base 200. The side of the base 200 also has an access panel 206 with a lock 211 for accessing the cavity defined by the base 200. The bottom of the base has a docking opening 245 that is configured to allow docking of the base to a docking plate. The docking opening 245 will be described in more detail starting at the description of FIG. 10.

FIG. 4 is a perspective view of a base mounted on a docking plate consistent with one embodiment of the technology disclosed herein. The docking plate 400 is configured to be installed on a surface such as a floor through floor couplers 402. The floor couplers 402 can be a variety of structures that secure the docking plate 400 to a surface. In at least one embodiment the floor couplers 402 are screws that are installed through clearance holes on the docking plate 400 into the surface. In another embodiment the floor coupler 402 can be a binding agent used to secure the docking plate 400 to the surface. Such binding agent can be substantially heavy duty so as to prevent translation of the docking plate 400 when subjected to the forces associated with normal operation of the system, which can depend on a variety of factors including, for example, the weight of the base 200, the weight of the machine (show in FIG. 1), and the force applied to the base 200 to move it from one location to another.

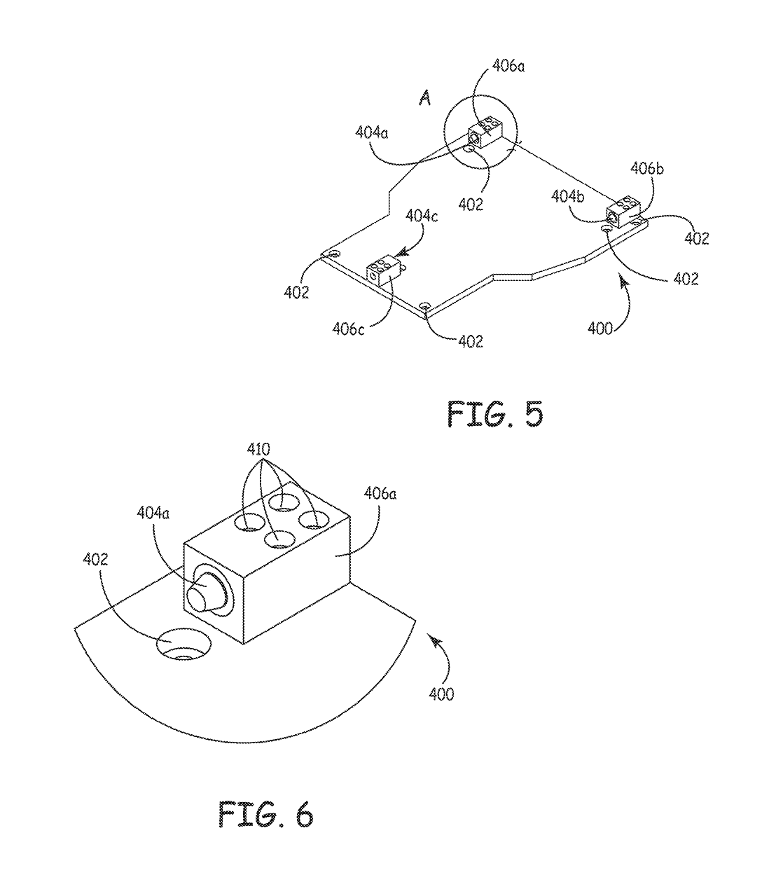

In various embodiments the base 200 is positioned substantially over the docking plate 400. The base 200 and docking plate 400 mutually engage through mating members and engaging members, which are described in more detail particularly in the description of FIG. 5 and FIG. 10, in addition to other figures below. A support structure 406c on the docking plate 400 supports a mating member. The mating member couples to an engaging member on the base 200 through the docking opening 245 of the base 200. This is described in more detail in the description of FIG. 10, below.

In various situations there can be multiple docking plates that are installed on surfaces of a floor in various locations to accommodate the base when moved to the various locations. The base 200 can be positioned over the docking plate 400 through the use of a forklift, as described above, manually rolled, a combination of the two, or through the use of other equipment that is generally known in the art. The multiple docking plates are substantially similar or identical to each other.

FIG. 5 is a perspective view of a docking plate consistent with one embodiment of the technology disclosed herein, with section A shown in an enlarged view in FIG. 6. There is a first support structure 406a, second support structure 406b, and third support structure 406c on the docking plate 400 that are coupled to the docking plate 400 with plate couplers 410. A first mating member 404a, second mating member 404b, and third mating member 404c are supported by the first support structure 406a, second support structure 406b, and third support structure 406c, respectively. The third mating member 404c is not visible in FIG. 5 because it is facing the direction opposite the first mating member 404a and second mating member 404b, respectively, but in multiple embodiments the third mating member is substantially similar to the first mating member 404a and second mating member 404b with respect to its function and, sometimes, shape. As mentioned above, the docking plate 400 also has floor couplers 402.

The clearance opening 240 of the base 200, which was described and depicted in FIG. 2 is configured to accommodate one or more of the support structures 406 depicted in the current figure when the base 200 is passed over the docking plate 400. In this particular embodiment, the clearance opening 240 of the base 200 is configured to provide clearance for the third support structure 406c when the base 200 is being rolled over the docking plate 400.

In at least one embodiment the plate couplers 410 are screws that are installed through clearance holes on the support structures 406 into the docking plate 400. In another embodiment the plate coupler 410 can be a binding agent used to secure the support structure 406 to the docking plate 400. Such binding agent can be substantially heavy duty so as to prevent translation of the support structure 406 when subjected to the forces associated with normal operation of the system, which can depend on a variety of factors including, for example, the weight of the base 200, the weight of the machine (show in FIG. 1), and the force applied to the base 200 to move it from one location to another. In some embodiments the binding agent can be a metal through welding or soldering, for example.

The mating members include a first mating member 404a, second mating member 404b, and third mating member 404c that are configured to mate with three corresponding engaging members (not shown) on the base 200, which are discussed in more detail in the discussion of FIG. 10, below. The three mating members 404a, 404b, and 404c define a plane of reference on which the base 200 can be precisely positioned. In the embodiment depicted, the mating members 404 are male protrusions, but in multiple embodiments the mating members 404 can be female openings. The mating members 404 can be at least partially tapered in some embodiments. The mating members 404a, 404b, 404c can be conical protrusions. In at least one embodiment the mating members 404a, 404b, 404c are hemispherical protrusions.

It will be appreciated that the mating members 404 can have a variety of shapes and sizes without deviating from the scope of the current technology. The mating members 404 are distributed on the docking plate 400 such that the bottom of the base 200 and, therefore, the base 200 would be substantially secured to the docking plate 400. In the embodiment shown, the mating members 404 each have a central axis that are parallel to a plane defined by the docking plate 400.

Each mating member 404a, 404b, 404c corresponds to engaging members on the bottom of the base so that each mating member 404 can be coupled to each engaging member. Consistent with FIG. 5 and FIG. 6, since the mating members 404 of the docking plate 400 are male, the engaging members on the base would be female with a complementary shape to the mating members so that a first engaging member can be coupled to the first mating member 404a, a second engaging member can be coupled to the second mating member 404b, and a third engaging member can be coupled to the third mating member 404c. In some embodiments the engaging members define cylindrical openings that can receive conical protrusions of the mating members or hemispherical protrusions of the mating members.

Each engaging member has an axis that substantially aligns with the axis of the each corresponding mating member when they are coupled. The coupling of the engaging members to the mating members 404 will be described in more detail in the explanation of FIG. 10, below.

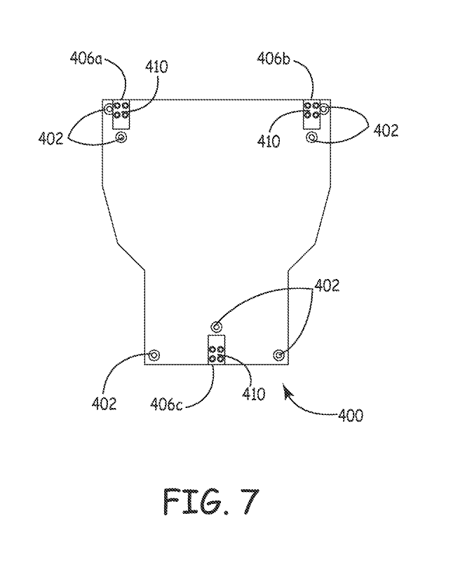

FIG. 7 is a top view of a docking plate, consistent with one embodiment of the technology disclosed herein without the mating members discussed above. The top view of the docking plate 400 provides a unrestricted view of the layout of the support structures 406, floor couplers 402, and plate couplers 410, as well as a the general shape of the docking plate 400 in this particular embodiment. Modifications to the layout and shapes associated with elements of the docking plate 400 may be varied without deviating from the scope of the current technology.

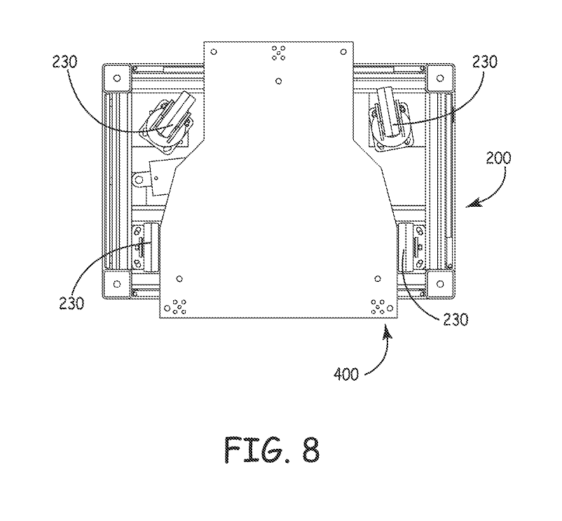

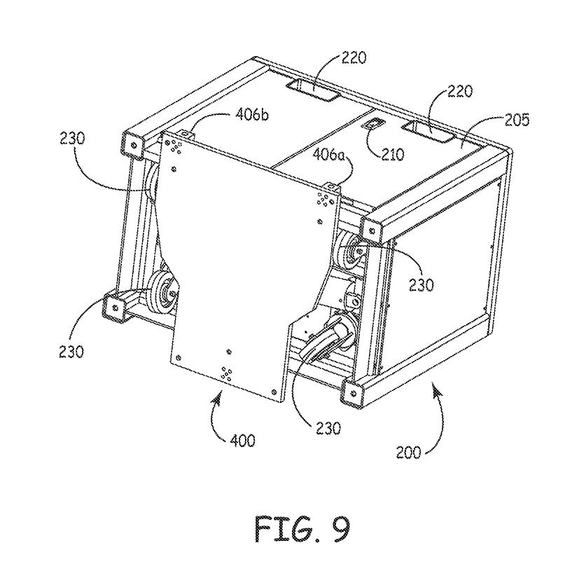

FIG. 8 is a bottom view of a base mounted on the docking plate consistent with one embodiment of the technology disclosed herein, and FIG. 9 is a perspective view from a slightly different angle of the view in FIG. 8. These views are consistent with looking “up” at the docking plate 400 and base 200 mounted thereon from below, and provide an unrestricted view of the layout of the wheels 230 relative to the base 200 and the docking plate 400. As can be observed, the wheels 230 are situated on the base 200 such that the base 200 can be moved over the docking plate 400 without the wheels 230 or the base 200 necessarily resting on the docking plate 400.

The docking plate 400 can be wider in the back 412 and narrower 414 in front to help guide the wheels 230 of the base 200 when rolled over the docking plate 400 from the front 414 to the back 412. Such a configuration guides the base 200 to a position over the docking plate 400 where the mating members and engaging members are at least partially aligned. Positioning of the base 200 with respect to the docking plate 400 such that the mating members and engaging members are at least partially aligned is relevant to coupling of the base 200 to the docking plate 400, as will be described in the explanation of FIG. 10, below.

FIG. 10 is a bottom perspective view of a base having a lock mechanism, also referred to as a lock, in an engaged position consistent with one embodiment of the technology disclosed herein. This figure provides a view of the bottom of the base 200 when mounted to the docking plate, without the docking plate itself obstructing the view of the bottom of the base 200. A first support structure 406a, second support structure 406b, and third support structure 406c of the docking plate (shown in FIG. 6) each have a first mating member 404a, second mating member 404b, and third mating member 404c (shown and discussed in FIG. 6) thereon, respectively, and each of the first mating member 404a, second mating member 404b, and third mating member 404c is coupled to a first engaging member 280a, second engaging member 280b (the first and second engaging members are depicted in FIG. 2), and third engaging member 280c, respectively, on the bottom of the base 200.

The coupling components of the mating member 404a, 404b, 404c and the engaging members 280a, 280b, 280c are not visible in this view because they are coupled and interconnected. Consistent with the docking plate 400 disclosed in FIG. 5, the base 200 has three corresponding engaging members that are female. In some embodiments, the base 200 has engaging members that are male and the docking plate has mating members that are female. In some embodiments some of the mating members 404a, 404b, 404c can be male while other mating members 404a, 404b, 404c can be female. It will be appreciated that the mating members 404a, 404b, 404c and engaging members 280a, 280b, 280c can be coupled in a variety of ways, even outside of the parts having entirely female-male relationships, without deviating from the scope of the current technology.

A locking mechanism 270 on the base has the third engaging member 280c positioned thereon that is configured to couple to the third mating member that is disposed on the third support structure 406c. The locking mechanism 270 can be moved to either engage or disengage. When the locking mechanism 270 is engaged, the third engaging member 406c positioned on the locking mechanism 270 couples to the third mating member of the docking plate 400 (of FIG. 5). When the locking mechanism 270 is disengaged, the third engaging member 406c separates from the third mating member of the docking plate.

The locking mechanism applies a force to from the third engaging member 280c to the third mating member on the third support structure 406c. When the base 200 is in position over the docking plate such that the first mating member at least partially aligns with the first engaging member, the second mating member at least partially aligns with the second engaging member, and the third mating member at least partially aligns with the path of travel of the third engaging member 280c through the docking opening 245, and the locking mechanism 270 is engaged, the force of the third engaging member on the third mating member causes reactionary forces between the first engaging member and the first mating member, and the second engaging member and the second mating member. Such force causes the coupling of the first engaging member to the first mating member, the second engaging member to the second mating member, and the third engaging member to the third mating member. Each axis of the engaging member aligns with each axis of the corresponding mating member. In one embodiment, when the locking mechanism is disengaged, the axis of each mating member is offset from the axis of each engaging member.

In various embodiments, as the locking mechanism 270 is engaged, the elevation of the base 200 increases relative to the surface to which the docking plate is secured (such as the floor). This can be due to, among other factors, the alignment of the mating members relative to the engaging members. For example, if the mating members are slightly higher than the engaging members, or the engaging members are slightly higher than the mating members, and at least either the male protrusions or the female openings are at least partially tapered, then as the locking mechanism 270 forces the coupling of the mating members and engaging members, the elevation of the base will increase when the locking mechanism moves from an engaged position to a disengaged position.

After engaging the locking mechanism, the weight of the base is supported only by the mated combination of the first engaging member to the first mating member, the second engaging member to the second mating member, and the third engaging member to the third engaging member. This allows a repeatable, substantially precise positioning of the base, as the mating members and engaging members define a plane of reference based on the points at which the mating members and engaging members are mated. The at least partially tapered configuration of either the male protrusions or female openings allows a casual alignment of the mating member and engaging members by the user that still results in a substantially precise, repeatable alignment when the locking mechanism is engaged.

The locking mechanism 270 can have a variety of embodiments that are consistent with the scope of the current application. FIGS. 10, 11, 12 and 13 provide multiple views of one embodiment of the locking mechanism 270 that, when viewed together, provide a better understanding of the system in light of the text presented herein.

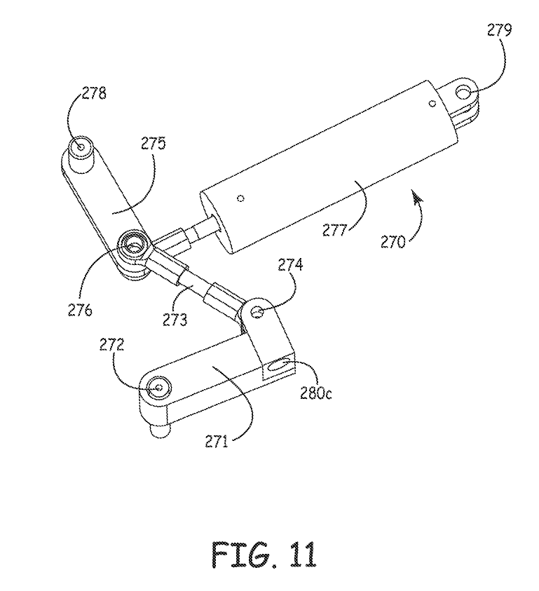

FIG. 11 shows a clear view of the locking mechanism 270 disconnected from the base, in an engaged orientation. The locking mechanism has four segments 271, 273, 275, 277 and the third engaging member 280c and five pivot points 272, 274, 276, 278, 279. As shown in FIGS. 10, 11 and 12, the first segment 271 is coupled to the third engaging member 280c and has a first pivot point 272 coupled to the base 200. The third engaging member 280c and the second segment 273 are coupled via a second pivot point 274. The second segment 273 shares a third pivot point 276 with a third segment 275 and a fourth segment 277. The third segment 275 pivots relative to the base 200 through a fourth pivot point 278, and the fourth segment 277 pivots relative to the base 200 through a fifth pivot point 279.

The locking mechanism 270 can be driven by a hydraulic system in various embodiments. In the particular embodiment of this discussion, the fourth segment 277 is a pneumatic cylinder of the locking mechanism 270 including a rod that travels in and out of a cylinder. The pneumatic component can be in electrical or mechanical communication with buttons, levers, pumps, and the like, that provide a user interface to engage and disengage the locking mechanism through operation of the pneumatic components. In some embodiments the pneumatic components automatically engage the locking mechanism when the base 200 is in an adequately aligned position over the docking plate to enable docking. In some embodiments, a user activated switch for the pneumatic cylinder of the locking mechanism is location in the base cabinet. The locking mechanism can be 270 driven by components different from, or in addition to, the pneumatic cylinder. Examples components include, but are not limited to, hydraulic, crank, or mechanical gear systems.

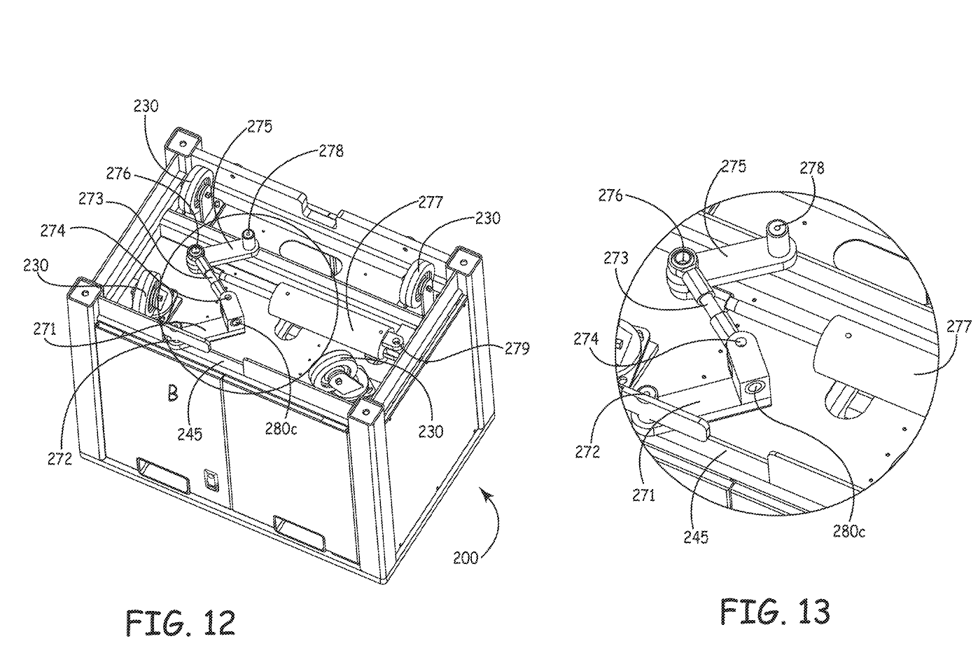

In a comparison of FIG. 10 and FIG. 12, it is observable that when the locking mechanism 270 is engaged (FIG. 9), the rod withdraws into the hydraulic cylinder 277, which pulls the third pivot 276 in a counterclockwise motion about the fourth pivot point 278 via the rigid third segment 275. This causes the third engaging member 280c pivoting about the first pivot point 272 in a clockwise direction to the docking opening 245 until it is coupled to the third mating member on the third support structure 406c.

When the locking mechanism 270 is disengaged (FIG. 12), the rod extends from the hydraulic cylinder 277, which pushes the third pivot 276 away from the fourth segment 277 in a clockwise direction about the fourth pivot point via the rigid third segment. This causes the third engaging member 280c to pivot about the first pivot point 272 in a counterclockwise direction to pull the third engaging member 280c away from the third mating member on the third support structure 406c. FIG. 13 provides a close-up view of Section B of FIG. 12 that shows the interactions of the different pivot points and segments of the locking mechanism 270 when the locking mechanism 270 is disengaged.

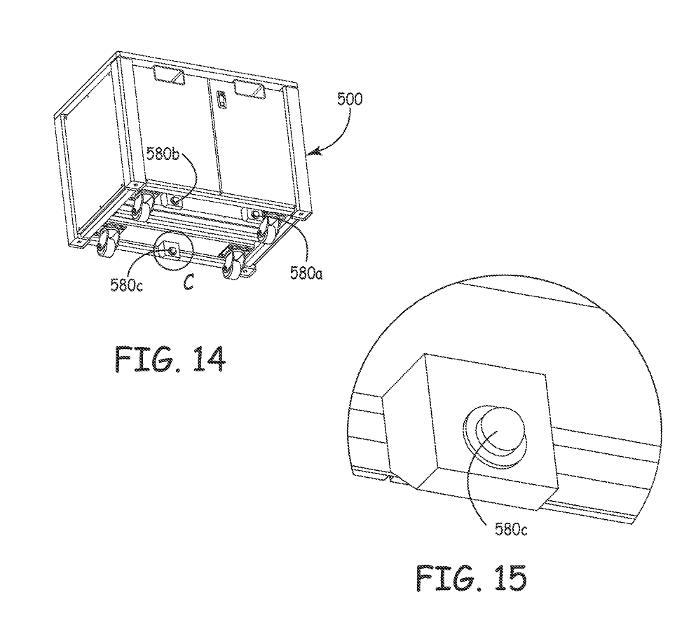

FIG. 14 is a bottom view of a base consistent with an alternative embodiment of the technology disclosed herein, and FIG. 15 depicts a close-up of section C in FIG. 14. In this embodiment the base 500 has a first engaging member 580a, second engaging member 580b, and third engaging member 580c that are male and would be received by a base plate with female mating members. The base 500 does not have a locking mechanism previous explains. In some embodiments consistent with FIG. 17, the locking mechanism may be coupled to the docking plate. In another embodiment, there may not be a locking mechanism at all.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as “arranged”, “arranged and configured”, “constructed and arranged”, “constructed”, “manufactured and arranged”, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

This application is intended to cover adaptations or variations of the present subject matter. It is to be understood that the above description is intended to be illustrative, and not restrictive.

We claim:

1. A machine base docking system comprising:
(a) a docking plate comprising a first mating member, a second mating member and a third mating member, wherein the docking plate is configured to be installed on a surface;
(b) a base comprising:
(i) a top surface configured to receive and secure a machine;
(ii) a first engaging member configured to couple to the first mating member,
a second engaging member configured to couple to the second mating member,
and a third engaging member configured to couple to the third mating member; and
(iii) a locking mechanism having the third engaging member positioned thereon, wherein the locking mechanism is moveable between an engaged position and a disengaged position, and where the third engaging member is coupled to the third mating member when the locking mechanism is in the engaged position.

2. The machine base docking system of claim 1 wherein the base comprises at least three wheels disposed to engage the surface.

3. The machine base docking system of claim 1:
a. wherein the first mating member, second mating member, and third mating member each have an axis parallel to a plane defined by the docking plate; and
b. wherein the first engaging member, second engaging member, and third engaging member each have an axis parallel to a plane defined by the docking plate.

4. The machine base docking system of claim 3 wherein either all of the mating members or all of the engaging members have at least a partially tapered configuration.

5. The machine base docking system of claim 4:
a. wherein when the locking mechanism is disengaged, the axis of the first mating member is offset from the axis of the first engaging member, the axis of the second mating member is offset from the axis of the second engaging member, and axis of the third mating member is offset from the axis of the third engaging member; and
b. wherein when the locking mechanism is engaged, the axis of the first mating member is aligned with the axis of the first engaging member, the axis of the second mating member is aligned with the axis of the second engaging member, and axis of the third mating member is aligned with the axis of the third engaging member.

6. The machine base docking system of claim 4, wherein the elevation of the base increases relative to the surface when the locking mechanism moves from the disengaged position to the engaged position.

7. The machine base docking system of claim 6, wherein when the locking mechanism moves from the disengaged position to the engaged position, the weight of the base is supported by the mated combination of the first engaging member to the first mating member, the second engaging member to the second mating member, and the third engaging member to the third engaging member.

8. The machine base docking system of claim 1 wherein each of the first mating member, second mating member, and third mating member are at least partially tapered.

9. The machine base docking system of claim 1:
a. wherein either all of the mating members or all of the engaging members are conical protrusions; and
b. wherein the other of the mating members or the engaging members define cylindrical openings for receiving the conical protrusions.

10. The machine base docking system of claim 1:
a. wherein either all of the mating members or all of the engaging members are hemispherical protrusions; and
b. wherein the other of the mating members or the engaging members define cylindrical openings for receiving the hemispherical protrusions.

11. The machine base docking system of claim 1 wherein the locking mechanism is moved between the engaged position and the disengaged position by a hydraulic system.

12. The machine base docking system of claim 1 wherein the locking mechanism is moved between the engaged position and the disengaged position by a mechanical system.

13. The machine base docking system of claim 1 wherein the locking mechanism is moved between the engaged position and the disengaged position by a pneumatic system.

14. The machine base docking system of claim 1 wherein the locking mechanism is pivotably mounted on the base.

15. The machine base docking system of claim 1, wherein the first engaging member, second engaging member, and third engaging member are on the bottom side of the base.

16. The machine base docking system of claim 1 wherein a bottom portion of the base defines a clearance opening corresponding to the third mating member of the docking plate.

17. The machine base docking system of claim 1 wherein the base defines sleeve openings in a top half of the base, wherein the sleeve openings are configured for receiving forklift prongs.

18. The machine base docking system of claim 1, further comprising a second docking plate defining a fourth mating member configured to couple to the first engaging member, a fifth mating member configured to couple to the second engaging member, and a sixth mating member configured to couple to the third engaging member.

19. The machine base docking system of claim 1 wherein the base defines an interior cavity for receiving control equipment for controlling a machine.

20. The machine base docking system of claim 1 further comprising a machine mounted to the top surface of the base.

21. A machine base docking system comprising:
(a) a base comprising:
(i) a top surface configured to receive and secure a machine;
(ii) three engaging members; and
(iii) a locking mechanism that is moved between the engaged position and the disengaged position by a pneumatic system;
(b) a first docking plate defining three mating members, where the three mating members are configured to couple to the three engaging members of the base;
(c) a second docking plate configured to be attached to a surface, the second docking plate comprising three mating members, wherein each of the three mating members are configured to couple to one of the three engaging members of the base; and
(d) wherein either all of the mating members or all of the engaging members have at least a partially tapered configuration; and
(e) wherein the base is configured to lock to either the first docking plate or the second docking plate and to move between the first docking plate and the second docking plate.

22. The machine base docking system of claim 21:
a. wherein either all of the mating members or all of the engaging members are conical protrusions; and
b. wherein the other of the mating members or the engaging members define cylindrical openings for receiving the conical protrusions.

23. The machine base docking system of claim 21:
a. wherein either all of the mating members or all of the engaging members are hemispherical protrusions; and
b. wherein the other of the mating members or the engaging members define cylindrical openings for receiving the hemispherical protrusions.

24. A method of installing a base docking system comprising:
(a) securing a first docking plate to a first surface, wherein the first docking plate comprises a first mating member, a second mating member and a third mating member;
(b) providing a base having a machine, wherein the base comprises a first engaging member configured to couple to the first mating member, a second engaging member configured to couple to the second mating member, and a third engaging member configured to couple to the third mating member;
(c) guiding the base to a position over the docking plate where mating members on the docking plate and engaging members on the base are at least partially aligned;
(d) activating a locking mechanism on the base to move the locking mechanism from a disengaged position to an engaged position, wherein the third engaging member is positioned on the locking mechanism and the third engaging member is coupled to the third mating member when the locking mechanism is in the engaged position;
(e) entering a first program into the machine to complete a first set of particular tasks from the first docking plate location.

25. The method of claim 24 further comprising:
storing the first program;
removing the base having the machine from the first docking plate;
re-docking the base having the machine to the first docking plate; and
running the first program after re-docking the base having the machine to the machine to the first docking plate.

26. The method of claim 24 where securing the first docking plate to the first surface comprises bolting the docking plate to the first surface.

27. The method of claim 25 further comprising:
securing a second docking plate to a second surface, wherein the second docking plate comprises a first mating member, a second mating member and a third mating member;
docking the base having the machine to a second docking plate;
entering a second program into the machine to complete a second set of particular tasks from the second docking plate location;
storing the second program;
removing the base having the machine from the second docking plate;
re-docking the base having the machine to the second docking plate; and
running the second program after re-docking the base having the machine to the second docking plate.
